(19) United States
(12) Patent Application Publication
(10) Pub. No.: US 2025/0100381 A1
(43) Pub. Date: Mar. 27, 2025

(54) Method for Operating a Driver-Assistance System of a Vehicle With Proactive Suggestion for Deactivating a Speed Warning, Driver-Assistance System and Vehicle

(71) Applicant: Bayerische Motoren Werke Aktiengesellschaft, Muenchen (DE)

(72) Inventors: Boris ISRAEL, Muenchen (DE); Walter KAGERER, Muenchen (DE); Simon KNEBEL, Muenchen (DE); Andreas LECHNER, Muenchen (DE); Wolfgang SPIESSL, Freising (DE)

(21) Appl. No.: 18/578,603

(22) PCT Filed: Jul. 8, 2022
(86) PCT No.: PCT/EP2022/069164

§ 371 Date: Jan. 11, 2024

(30) Foreign Application Priority Data
Jul. 13, 2021 (DE) 10 2021 118 054.6

(51) Int. Cl. B60K 35/28; G01C 21/36

(52) U.S. Cl. CPC B60K 35/28; G01C 21/3697; B60K 2360/166; B60K 2360/167; B60K 2360/178; B60K 2360/741

(57) ABSTRACT

A method for operating a driver-assistance system of a vehicle includes the following steps: sensing a permissible maximum speed for a road on which the vehicle is moving during a current trip and/or will be moving in the future, automatically activating a speed warning for warning a user if a speed of the vehicle during the current trip exceeds the permissible maximum speed, defining a driving situation for the trip on the basis of the behavior of the user during the current trip and/or in previous trips with the vehicle and/or on the basis of the behavior of other road users, determining on the basis of the defined driving situation whether a deactivation of the speed warning should take place, and issuing a suggestion to the user to deactivate the speed warning if the speed warning is to be deactivated.

### BACKGROUND AND SUMMARY

The present invention relates to a method for operating a driver assistance system of a vehicle. In addition, the present invention relates to a driver assistance system for a vehicle. Finally, the present invention relates to a vehicle with such a driver assistance system.

Various driver assistance systems are known from the prior art that can assist a driver or user in driving the vehicle. For example, driver assistance systems are known which display the currently permissible maximum speed to the user. For this purpose, traffic signs can be recognized, for example with a camera of the vehicle. This function can also be extended by cruise control or longitudinal control. If, for example, the user has selected to adopt the speed limit when cruise control is activated, the driver assistance system adjusts the speed according to a manual input by the user or automatically to the signage or the currently permissible maximum speed.

In addition, so-called speed limiters are known from the prior art. In such a system, a speed limit can be set by the driver, for example, in order not to exceed the currently permissible maximum speed. In this context, too, it is known that a detected change in the permissible maximum speed is manually or automatically adopted for the speed limiter as a new speed limit.

In addition, speed control with distance control is known from the prior art. This feature can also be referred to as adaptive cruise control (ACC). This function can also automatically determine the distance or safety distance to a vehicle ahead and can adjust the speed of the vehicle accordingly. Also, the currently permissible maximum speed or the speed limit can be adopted with this cruise control.

Furthermore, speed warning is known from the prior art. Here the user is warned accordingly if the current speed of the vehicle exceeds the maximum permissible speed for the road on which the vehicle is currently moving. New legislation, rules and regulations, such as, for example, the General Safety Regulation, which will apply in Europe in the future, regulates the warning in the event of speeding. For example, it is envisaged that there will be a very clearly perceptible and permanent warning over various channels as soon as the current permissible speed limit is exceeded.

However, in certain situations or even in certain regions, the speed warning can also distract the user from the traffic situation or disturb the user. For example, in regions with inadequate infrastructure, the determination of the maximum permissible speed may reach the limits of the system and lead to unwarranted and erroneous warnings. It may also be the case that the speed warning is issued on the basis of information that is no longer valid for the road being travelled. An incorrect or unwanted speed warning can cause the user to feel disturbed or unsettled by the driver assistance system. In addition, the user may be distracted by the speed warning and it may be the case that acceptance of the speed warning or use of the driver assistance system decreases.

It is the object of the present invention to reveal a solution by which a user can be supported in an effective way when using a driver assistance system with speed warning. In addition, a vehicle should be provided with such a driver assistance system.

According to the invention, this object is achieved by a method, by a driver assistance system and by a vehicle with the characteristics of the independent claims.

Advantageous developments of the present invention are indicated in the dependent claims.

A method according to the invention is used to operate a driver assistance system of a vehicle. The method includes the detection of a maximum permissible speed for a road on which the vehicle is moving during a current trip or is most likely to move in the future. In addition, the method includes the automatic activation of a speed warning for warning a user if the speed of the vehicle exceeds the maximum permissible speed during the current trip. Furthermore, the method includes the definition of a driving situation for the trip on the basis of the behavior of the user during the current trip and/or previous trips with the vehicle and/or on the basis of the behavior of other road users. In addition, the method includes determining whether the speed warning should be deactivated on the basis of the defined driving situation. Further, the method includes issuing a suggestion to the user to deactivate the speed warning in the event that the speed warning should be deactivated.

With the help of the driver assistance system, the currently permissible maximum speed for the road on which the vehicle is currently located or moving can be determined. The permissible maximum speed describes in particular the maximum speed currently applicable to the vehicle. The current maximum permissible speed can also be determined for a single road of the road on which the vehicle is currently moving. The maximum permissible speed can also be referred to as the speed limit. In addition, the maximum permissible speed can be determined for the road on which the vehicle will move with a very high probability in the future. This means that it is also possible that upcoming speed limits are detected. In order to be able to determine the maximum permissible speed, a camera of the driver assistance system can be used to record corresponding traffic signs, information signs, displays of traffic control systems, gantries or the like. Furthermore, digital map data can be used to determine and/or check the plausibility of the permissible maximum speed.

It is also envisaged that the speed warning will be activated automatically. This speed warning can be triggered automatically after the vehicle has been started or after a terminal change and/or after a change of user. In this case, a warning can be issued to the user or driver of the vehicle if the current speed of the vehicle exceeds the recorded maximum permissible speed. This applies in the event that the vehicle is being manually maneuvered by the driver. In addition, this applies in the event that the control of the longitudinal speed of a vehicle will be taken over by the driver assistance system. In principle, the speed warning can be issued acoustically, visually and/or haptically. It may also be provided that the speed warning is issued in several stages. For example, it may first be warned visually and then acoustically. The speed warning can also be issued several times in succession.

According to the present invention it is envisaged that the current trip of the vehicle is assigned a defined driving situation. When defining the driving situation, the behavior of the user or driver during the current trip can be taken into account. Alternatively or additionally, the behavior of the user during previous trips with the vehicle can be taken into account in order to define the driving situation. During the operation of the vehicle, observations can therefore be carried out continuously, which characterize the driving behavior of the user. Based on the behavior of the user during the current trip and/or the previous behavior of the user, a driving situation can then be defined for the current trip. Alternatively or additionally, it may be provided that the behavior of at least one other road user is used to define the driving situation. In other words, for the current trip of the vehicle, it can be estimated how the driver of the vehicle himself and/or other road users would behave or how they would react to the speed warning. In principle, it may also be provided that a number of predetermined driving situations are specified and that one of these driving situations is selected for the current trip of the vehicle, or that one of these predetermined driving situations is assigned to the current trip.

On the basis of the defined driving situation, it can now be determined whether the speed warning should be deactivated. In other words, on the basis of the defined driving situation, it is determined whether the user of the vehicle will be warned about exceeding the currently permissible maximum speed or not. If, based on the defined driving situation, it is ascertained that the speed warning should be deactivated, the suggestion for deactivating the speed warning is issued to the user. For example, this suggestion can show the user how to deactivate the speed warning. It may also be provided that the user is prompted for a corresponding operating input, by which the speed warning is then deactivated. In this way, in the event of an unjustified or erroneous speed warning, the user can be issued a proactive suggestion for deactivating the speed warning.

As explained above, the driving situation can be determined based on the current and/or previous behavior of the user and/or the behavior of other road users. For example, various parameters or criteria can be defined that describe the behavior of the user since the beginning of the current trip and/or the historical behavior of the user and/or the behavior of other road users. On the basis of these parameters, the driving situation can then be defined or a driving situation can be selected from a number of predefined driving situations. It may also be envisaged that an observation algorithm will be developed which, based on certain probabilities, will determine whether or not the user wants to be warned of exceeding the permissible speed limit during the current trip.

If it is determined that the user has a high probability of wanting to deactivate the speed warning, it can be suggested to the user to deactivate the speed warning, at least temporarily. The user can also be shown or explained how to deactivate the speed warning themselves. Here the deactivation can be carried out by at least one operating action by the user, a voice input, an operating gesture or the like. The user can also be shown how to call up a control menu for deactivation or how to save a so-called bookmark or a quick access to the operating menu. In addition, it may be provided that the speed warning is automatically deactivated if it is detected that the user has a high probability of wanting to deactivate the speed warning. In this case, the user can be informed of the completed deactivation.

In one embodiment, the trip is assigned a location, a route and/or route guidance and the driving situation is defined depending on the assigned location, the assigned route and/or the assigned route guidance. For example, a location can be assigned to the current trip of a vehicle. In the present case, a location is, for example, an area, a region, a country or the like. For example, it can be taken into account whether or not it is a region with inadequate infrastructure. A route can also be assigned to the current trip. The route can describe whether the vehicle is currently moving in urban areas, on a country road, a motorway or the like. Here, the type of road can also be taken into account when defining the driving situation. In addition, for example, the condition of the road, the state of development of the road or the like can be taken into account. For example, it can be taken into account whether it is a winding road, a road with inclines and/or declines or the like. In addition, the current trip can be assigned route guidance. Here, for example, information from a navigation system of a vehicle can be taken into account. In particular, the future course of the route can also be taken into account when defining the driving situation. All in all, therefore, the driving situation can be determined on the basis of the local conditions and/or the design of the road.

In another embodiment, the driving situation is defined on the basis of the behavior of the user during the current trip and/or previous trips at a similar or the same place, on a similar route or the same route and/or during similar route guidance or the same route guidance. When defining the driving situation, it is therefore possible to take into account how the driver has behaved during the current trip and/or previously on similar roads, road types or the like. It can also take into account how the driver has previously behaved in similar areas, in similar traffic situations, or the like. In addition, account may be taken of whether the user or driver has usually manually deactivated the speed warning at such a location, on such a route or in the event of such route guidance.

In a further embodiment, the driving situation is determined on the basis of the behavior of the other road users at a similar or the same location, on a similar route or the same route and/or during similar route guidance or the same route guidance. For example, it can be taken into account how other drivers or road users behaved on the same route at an earlier point in time. For example, it may be the case that the route currently being traveled by the vehicle has at least one incorrectly detected or incorrectly specified speed limit. This can be recognized, for example, by the fact that many other road users who are currently driving this route or have driven on it in the past are driving at a different speed than the recognized maximum permissible speed. In this case, for example, the driving situation can be defined in such a way that the driver is highly likely to want to deactivate the speed warning.

In order to be able to determine the behavior of other road users, data can be determined and/or received which describe the behavior of other road users. These data can be determined, for example, with the help of environment sensors of a vehicle. In particular, the environment sensors can be used to determine the speed of other road users. Furthermore, the data can be transferred from a server or a backend to the vehicle. In addition, vehicle-to-vehicle communication and/or vehicle-to-infrastructure communication can be transferred to the vehicle.

Another embodiment provides that the behavior of the user describes whether a manual deactivation of the speed warning for the current trip and/or previous trips has been carried out by the user. For example, if it is generally detected that the user is deactivating the speed warning, it can be assumed that the user also wants to deactivate the speed warning for the current trip. Here it can also be taken into account or can be recognized in the case of previous trips that the user deactivates the speed warning after a defined time following starting the vehicle. In this case, the proactive suggestion for deactivating the speed warning can be issued after a certain or defined period of time.

According to a further arrangement, the behavior of the user describes whether the user has ignored the speed warning during the current trip and/or previous trips. For example, it may be the case that the driver has ignored or not observed speed warnings issued during previous trips. This can be seen, for example, from the fact that the user has manually driven the vehicle at a speed higher than the maximum permissible speed. Also, in the case of such a driving situation or such behavior of the user, it can be assumed that the user wishes to deactivate the speed warning.

It may also be provided that the proactive suggestion for deactivating the speed warning is issued if the user has completely ignored a predetermined number of speed warnings per trip or during the current trip. For example, the proactive suggestion can be issued if the speed warning has been completely ignored between two and ten times per trip. In the present case, the term “completely ignored” means that the user has not reacted to visual warnings or displays, nor to any additionally issued audible warnings that may have been issued.

The proactive suggestion for deactivating the speed warning can be issued audibly and/or haptically. In particular, it is envisaged that the suggestion will be issued visually or as a display. It may also be provided that the proposal will be displayed for a predetermined period of time. The length of time can be between one second and ten seconds, wherein the time duration can be six seconds, for example. In addition, it may be provided that the suggestion will be displayed again if the user has not seen the displayed suggestion. For example, the suggestion can be issued if the user has completely ignored a predetermined number of speed warnings per trip, such as between two and ten consecutive speed warnings.

Furthermore, the proactive suggestion can be displayed for a predetermined number of trips of the user. For example, the suggestion may only be issued for the first five trips per user. In addition, a further output of the proactive suggestion may be omitted if the user has already performed an operating action on at least one issued suggestion or if an interaction has been carried out by the user. For example, issuing further proactive suggestions can be stopped if the user has interacted with the suggestion twice. This interaction may be an operating action carried out on a touch display or the like, for example.

In another embodiment, the behavior of the user describes whether the user has defined an adjustment value for a speed limit and/or cruise control of the vehicle. The driver assistance system can also be used to enable longitudinal control or speed control of the vehicle. Here the speed of the vehicle or the longitudinal speed of the vehicle can be controlled to a set speed that corresponds to the sum of the currently recorded maximum speed and an adjustment value or offset. This adjustment value can be set by the driver. In addition, it may be provided that the distance or safety distance to a road user ahead is automatically adjusted during longitudinal control by adjusting the speed of the vehicle. In other words, the adaptive cruise control can be provided with the driver assistance system. In addition, a speed limiter can be provided by means of the driver assistance system. Here, too, an adjustment value or offset can be specified by the driver for the speed limit of the speed limiter. If it is detected here that the user has set a positive adjustment value or an adjustment value that exceeds a predetermined minimum value, it can be assumed that the driver wishes to deactivate the speed warning.

In another embodiment, the behavior of the other road users describes whether the other road users are moving at a higher speed than the recognized maximum speed. This means that it is possible to check whether other drivers or road users are driving at a higher speed than the currently recognized maximum permissible speed. In this case, too, it can be assumed that the driver wants to deactivate the speed warning. This also applies in the event that the user has driven the vehicle on a similar route or the same route at a higher speed than the currently recognized maximum permissible speed.

A driver assistance system according to the invention for a vehicle is set up to carry out a method according to the invention and the advantageous arrangements thereof. The driver assistance system can be set up to detect a maximum permissible speed for the road on which the vehicle is currently moving and/or will most likely do so in the future. For this purpose, the driver assistance system can have at least a camera and, on the basis of the image data from the camera, can recognize corresponding traffic signs in the vicinity of the vehicle and derive the permissible maximum speed from this. In addition, the maximum permissible speed may be determined and/or checked for plausibility on the basis of map data and/or data of a navigation system.

In addition, the driver assistance system can be used to automatically activate the speed warning, for which a warning will be issued if the current speed of a vehicle exceeds the maximum permissible speed. By means of the driver assistance system or a computing device of the driver assistance system, a driving situation can be assigned to a current trip of the vehicle. This driving situation can be determined on the basis of the past behavior of the user and/or on the basis of the behavior of other road users. Depending on the defined driving situation, it can then be decided whether or not the driver or user wishes to deactivate the speed warning. If it is assumed from this that the user wishes to deactivate the speed warning, a message for deactivating the speed warning can be proactively issued to the driver by means of an output device.

A vehicle according to the invention contains a driver assistance system according to the invention. The vehicle is in the form in particular of a passenger car.

The preferred embodiments presented with reference to the method according to the invention and their advantages apply accordingly to the driver assistance system as well as to the vehicle according to the invention.

Further features of the invention arise from the claims, the figures and the description of the figures. The features and combinations of features mentioned above in the description, as well as the features and combinations of features mentioned below in the description of the figures and/or shown in the figures alone, are not only able to be used in the combination specified in each case but can also be used in other combinations or on their own, without departing from the scope of the invention.

The invention is now explained in more detail on the basis of preferred exemplary embodiments as well as with reference to the attached drawings. In the figures:

### BRIEF DESCRIPTION OF THE DRAWINGS

FIG. 1 shows a schematic representation of a vehicle equipped with a driver assistance system for issuing a speed warning; and

FIG. 2 shows the vehicle according to FIG. 1 in an exemplary traffic situation.

### DETAILED DESCRIPTION OF THE DRAWINGS

In the figures, identical or functionally identical elements are provided with the same reference signs.

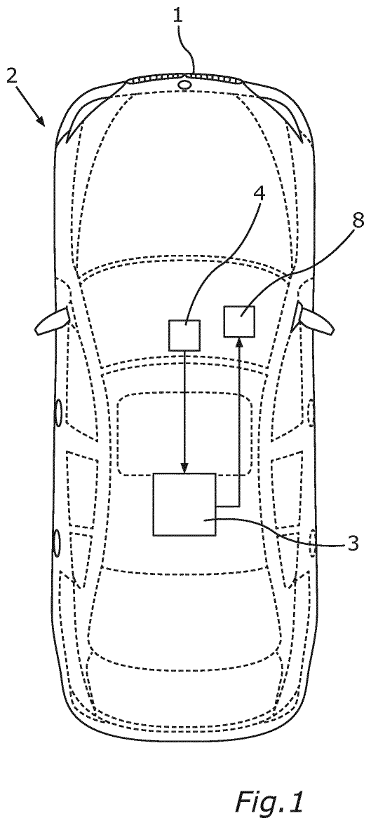

FIG. 1 shows a schematic representation of a vehicle 1, which in the present case is in the form of a passenger car, in a top view. The vehicle 1 contains a driver assistance system 2, which is used to assist a user or driver in driving the vehicle 1.

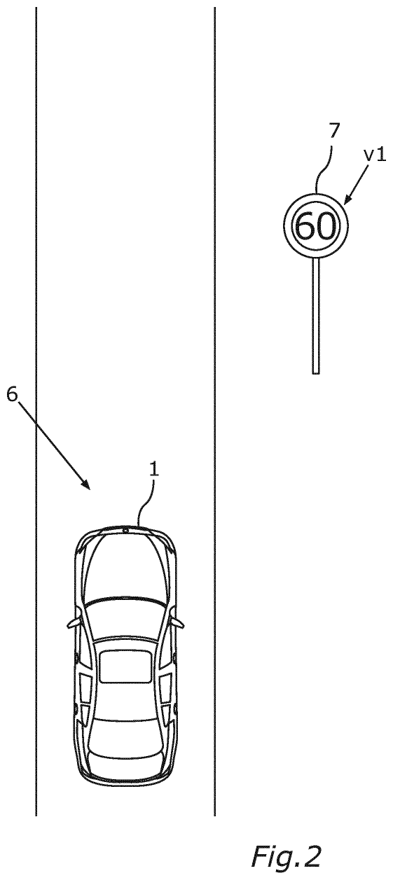

In the present example, the driver assistance system 2 contains a camera 4, by means of which information can be recorded about a permissible maximum speed v1 on the road 6 on which vehicle 1 is currently located and/or is most likely to move in the future. For example, the camera can be used to record a traffic sign 7 which describes the maximum permissible speed v1 (see FIG. 2).

In addition, the driver assistance system 2 contains a computing device 3, which can be formed by at least one electronic control unit of the vehicle 1, for example. The computing device 3 is connected to the camera 4 for data transmission and can thus evaluate image data provided by the camera 4 accordingly. In addition, the computing device 3 can receive digital data and determine or plausibility check the permissible maximum speed v1 on the basis of these data. These data can be navigation data or digital map data. The digital data can be received from a navigation system, a backend or the like. It may also be envisaged that the digital data will be transmitted to the vehicle 1 via vehicle-to-vehicle communication and/or via vehicle-to-infrastructure communication.

In addition, the driver assistance system 2 contains an output device 8 by means of which a speed warning can be issued to the user. This warning or speed warning can be issued visually, acoustically and/or haptically. The speed warning can be issued in the event of a current speed of the vehicle 1 exceeding the recorded specified maximum speed v1. This speed warning can be activated automatically when the vehicle 1 is started or after a terminal change or a change of user.

The driver assistance system 2 is also set up to determine the behavior of the user during the operation of the vehicle 1. For example, the driver assistance system 2 can record whether the user has ignored the speed warning and/or manually deactivated it during the current trip and/or previous trips with the vehicle 1. It can also be recorded on which type of route, at which location and/or for which route guidance the user has deactivated the speed warning. It can also be recorded whether, for example, the user has deactivated the speed warning after a certain period of time after starting the vehicle 1. Furthermore, the behavior of the user can be recorded as to whether he or she has provided an adjustment value or offset for cruise control or speed limiting during the operation of the vehicle 1.

Furthermore, the driver assistance system 2 can be set up to receive data that describe the behavior of at least one other road user. In particular, data can be received which describe the speed of other road users on the route or in the section of the route that the vehicle 1 is currently traversing. These data can be received with a communication device of the driver assistance system 2 that is not shown.

For example, these data may be received from an infrastructure facility, a server, via vehicle-to-vehicle communication, via vehicle-to-infrastructure communication, or the like.

FIG. 2 shows an example of a traffic situation in which the vehicle 1 is on a road 6 according to FIG. 1. This road 6 is assigned a maximum permissible speed v1 of 60 km/h. This maximum permissible speed v1 can be detected by the camera 4 of the driver assistance system 2 on the basis of the traffic sign 7.

In the present case, it is assumed that the current speed of the vehicle 1 is 63 km/h. Thus, the current speed of the vehicle 1 is above the maximum permissible speed v1 and the speed warning is issued to the user by means of the output device 8.

On the basis of the previously described behavior of the user during the current trip and/or during the previous trips and/or on the basis of the previously determined behavior of the other road users, a driving situation can be defined for the current trip of the vehicle 1 on the road 6. From this driving situation it can then be derived whether the user wants to deactivate the speed warning. For example, an observation algorithm can be developed and/or used that, based on certain probabilities, determines whether the user wants to be warned here or would prefer to deactivate the warning. If it is recognized that the user has a high probability of wanting to deactivate the speed warning, it can be proactively suggested to the user to deactivate the speed warning.

In particular, the proactive suggestion can be issued if the user has completely ignored the speed warning, for example, twice to ten times per trip. If the issued suggestion is not observed by the user, after ignoring the speed limit, for example two to ten times per trip, a new suggestion can be issued. For example, the suggestion can be issued for the first five trips of the user or per driver ID. In addition, further suggestions can be omitted if the user has interacted with the suggestion twice.

1.-10. (canceled).

11. A method for operating a driver assistance system of a vehicle, the method comprising:
detecting a maximum permissible speed for a road on which the vehicle is moving during a current trip and/or will move in the future;
automatically activating a speed warning for warning a user if a vehicle speed exceeds the maximum permissible speed during the current trip;
defining a driving situation for the trip based on a behavior of the user during the current trip and/or previous trips with the vehicle and/or based on the behavior of other road users;
determining, based on the defined driving situation, whether the speed warning should be deactivated; and
issuing a suggestion to the user to deactivate the speed warning if the speed warning should be deactivated.

12. The method according to claim 11, wherein a location, a route and/or a route guidance is assigned to the trip and the driving situation is defined depending on the assigned location, the assigned route and/or the assigned route guidance.

13. The method according to claim 12, wherein the driving situation is defined based on the behavior of the user during the current trip and/or previous trips at a similar location or a same location and/or a similar route or a same route.

14. The method according to claim 12, wherein the driving situation is defined based on the behavior of other road users at a similar location or a same location and/or a similar route or a same route.

15. The method according to claim 13, wherein the driving situation is defined based on the behavior of other road users at a similar location or the same location and/or a similar route or a same route.

16. The method according to claim 11, wherein the behavior of the user describes whether a manual deactivation of the speed warning has been carried out by the user during the current trip and/or previous trips.

17. The method according to claim 12, wherein the behavior of the user describes whether a manual deactivation of the speed warning has been carried out by the user during the current trip and/or previous trips.

18. The method according to claim 13, wherein the behavior of the user describes whether a manual deactivation of the speed warning has been carried out by the user during the current trip and/or previous trips.

19. The method according to claim 11, wherein the behavior of the user describes whether the user has ignored the speed warnings during the current trip and/or previous trips.

20. The method according to claim 12, wherein the behavior of the user describes whether the user has ignored the speed warnings during the current trip and/or previous trips.

21. The method according to claim 13, wherein the behavior of the user describes whether the user has ignored the speed warnings during the current trip and/or previous trips.

22. The method according to claim 11, wherein the behavior of the user describes whether the user has specified an adjustment value for speed limiting and/or cruise control for the current trip and/or previous trips.

23. The method according to claim 12, wherein the behavior of the user describes whether the user has specified an adjustment value for speed limiting and/or cruise control for the current trip and/or previous trips.

24. The method according to claim 13, wherein the behavior of the user describes whether the user has specified an adjustment value for speed limiting and/or cruise control for the current trip and/or previous trips.

25. The method according to claim 11, wherein the behavior of other road users describes whether the other road users are moving at a speed higher than the recorded maximum speed.

26. The method according to claim 12, wherein the behavior of other road users describes whether the other road users are moving at a speed higher than the recorded maximum speed.

27. The method according to claim 13, wherein the behavior of other road users describes whether the other road users are moving at a speed higher than the recorded maximum speed.

28. A driver assistance system for a vehicle, wherein the driver assistance system is set up to carry out a method according to claim 11.

29. A driver assistance system for a vehicle, wherein the driver assistance system is set up to carry out a method according to claim 12.

30. A passenger car containing a driver assistance system according to claim 28.
